(19) United States
(12) Patent Application Publication
(10) Pub. No.: US 2011/0020680 A1
(43) Pub. Date: Jan. 27, 2011

(54) FIXING MECHANISM

(75) Inventor: ZHI-HUA LIU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY CO., LTD., Shenzhen City (CN); HON HAI PRECISION INDUSTRY CO., LTD., Tu-Cheng (TW)

(21) Appl. No.: 12/555,948

(22) Filed: Sep. 9, 2009

(30) Foreign Application Priority Data
Jul. 22, 2009 (CN) 200910304681.X

(51) Int. Cl. H01M 2/10

(52) U.S. Cl. 429/96

(57) ABSTRACT

A fixing mechanism includes: a battery holder comprising a hollow sleeve, the sleeve defining a chamber to receive a battery and an opening extending along a direction substantially parallel to a center axis of the battery holder; and a resilient battery cover sealing the opening of the battery holder. The sleeve further includes a latching portion defined in an inner surface thereof adjacent to the opening; and the resilient battery cover further includes at least one latching hook locked with the latching portion.

### BACKGROUND

1. Technical Field

The present disclosure generally relates to fixing mechanisms and, particularly, to a fixing mechanism for fixing a battery in a battery holder.

2. Description of Related Art

An electronic device, such as a wireless keyboard, a wireless touchpad, a remote control, and the like, usually includes a battery to provide electrical power. A fixing mechanism for fixing a battery in the electronic device is often utilized to facilitate installing and uninstalling the battery.

A typical fixing mechanism includes a battery holder and a detachable battery cover. The battery holder includes a sleeve defining at least one opening end. The sleeve defines a chamber to receive the battery. The battery cover is used to seal the opening end of sleeve. The sleeve further defines an inner screw threading in an inner surface of the chamber adjacent to the opening end. The body portion of the battery cover defines an outer screw threading corresponding to the inner screw threading, such that the body portion of the battery cover may be screwed into the opening end of the sleeve. However, the electronic device usually further includes a pair of electrical connecting members and a current-limiting printed circuit board (PCB). The electrical connecting members are positioned at two ends of the battery in the chamber to electrically connect two electrodes of the battery. The current-limiting PCB is electrically connected to one of the electrical connecting members adjacent to the battery cover. If a user wants to replace the battery, the battery cover, the electrical connecting member and the current-limiting PCB must be disassembled from the sleeve. Thus, it is relatively inconvenient to replace the battery.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is an exploded, isometric view of a first embodiment of a fixing mechanism.

FIG. 2 is similar to FIG. 1, but viewed in another aspect.

FIG. 3 is an enlarged, side cross-sectional view of the fixing mechanism of FIG. 1, taken along line III-III.

FIG. 4 is an exploded, isometric view of a second embodiment of a fixing mechanism.

### DETAILED DESCRIPTION

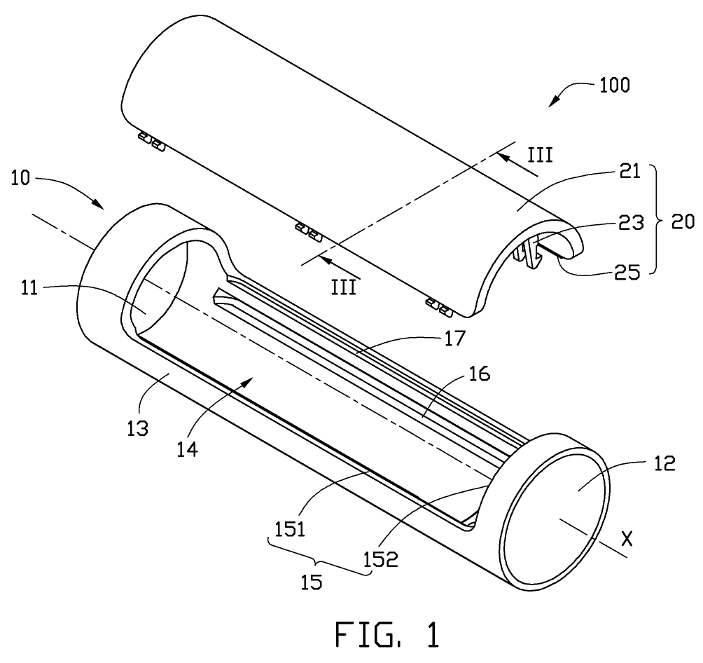

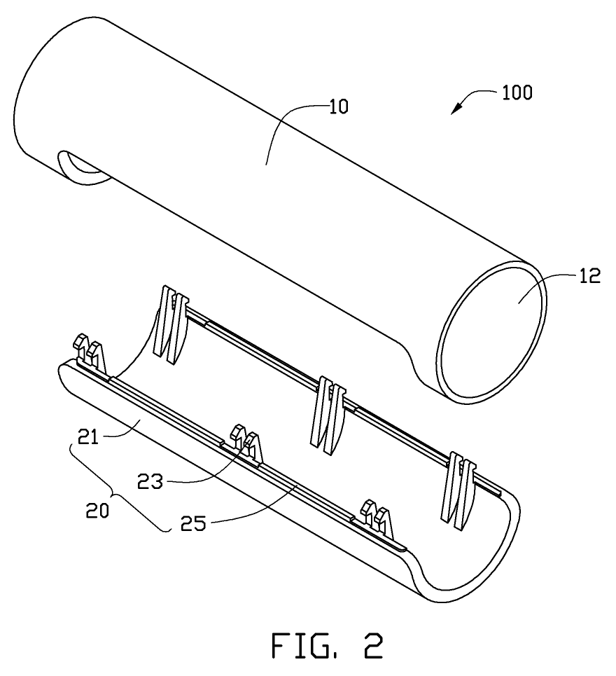

Referring to FIGS. 1 and 2, a first embodiment of a fixing mechanism 100 includes a battery holder 10, and a resilient battery cover 20 fixed to the battery holder 10. The fixing mechanism 100 is used to fix a battery (not shown) in the battery holder 10 with the resilient battery cover 20. The fixing mechanism 100 can be employed in an electronic device (not shown), such as a wireless keyboard, a wireless touchpad, a remote control, and so on.

The battery holder 10 can be substantially cylindrical. The battery holder 10 includes a first end cover 11, a second end cover 12, and a hollow sleeve 13. In the illustrated embodiment, the sleeve 13 is substantially cylindrical. The sleeve 13 defines a chamber 14. The first end cover 11 and the second end cover 12 are fixed to two ends of the sleeve 13 by, for example, by adhesive or welding. The sleeve 13 defines an elongated opening 15 extending along a direction substantially parallel to a center axis X of the battery holder 10. In other words, the sleeve 13 includes a pair of elongated edges 151 substantially parallel to the center axis X and a pair of curved edges 152 substantially parallel to the first and second end covers 11, 12. The elongated edges 151 and the curved edges 152 cooperatively define the elongated opening 15.

The sleeve 13 further defines a pair of latching portions 16 and a pair of limiting portions 17. In the illustrated embodiment, each latching portion 16 is an elongated latching depression defined at an inner surface of the sleeve 13 extending along a direction substantially parallel to the center axis X adjacent to each elongated edge 151. Each limiting portion 17 is an elongated cutout defined on each elongated edge 151 and communicating with the chamber 14.

The resilient battery cover 20 can be fixed to the sleeve 13 to seal the elongated opening 15. The resilient battery cover 20 includes a curved body 21, a plurality of latching hooks 23 and a plurality of latching rims 25. In the illustrated embodiment, a shape of the curved body 21 complements the sleeve 13 to form an integral appearance. The curved body 21 is made of elastic materials, such as elastic resins and an elastic metallic sheet.

The latching hooks 23 are formed at an inner surface of the curved body 21 adjacent to opposite edges of the curved body 21 corresponding to the latching portions 16. The latching hooks 23 can be locked in the corresponding latching portions 16. In the illustrated embodiment, each of the latching hooks 23 is substantially L-shaped. The latching rims 25 extend out from the opposite edges of the curved body 21 corresponding to the limiting portions 17. The latching rims 25 can be received in the limiting portions 17 to be blocked by the battery holder 10.

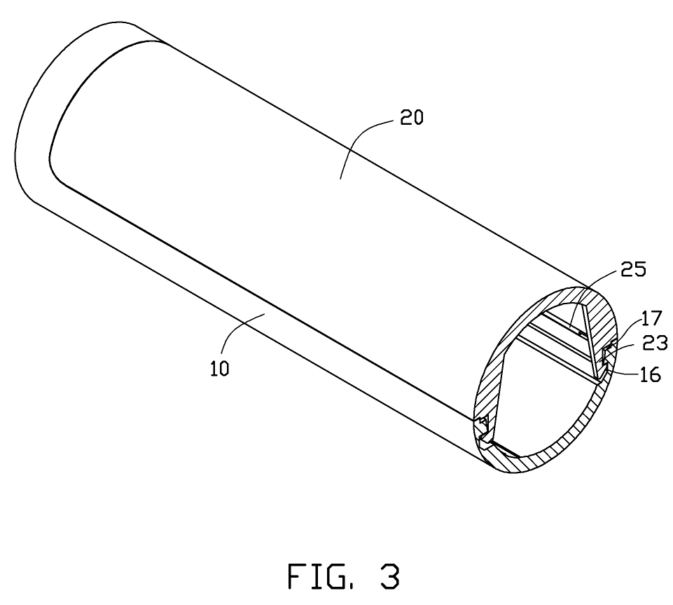

Referring to FIGS. 1 through 3, after the battery is received in the chamber 14 of the battery holder 10, the resilient battery cover 20 is fixed to the battery holder 10 as follows. Firstly, an external force is applied at opposite edges of the resilient battery cover 20 adjacent to the latching hooks 23, and then the resilient battery cover 20 is bent inwards. Secondly, the bent resilient battery cover 20 acted by the external force is placed into the elongated opening 15. Finally, when the external force is withdrawn, the resilient battery cover 20 rebounds, the latching hooks 23 are locked in the corresponding latching portions 16, and the latching rims 25 are received in the limiting portions 17 and blocked by the limiting portions 17. Accordingly, the resilient battery cover 20 is fixed on the sleeve 13 of the battery holder 10.

To disassemble the resilient battery cover 20 from the battery holder 10, an external force is applied to bend the resilient battery cover 20 inward relative to the sleeve 13. At this time, the latching hooks 23 may be detached from the latching portions 16. Finally, the resilient battery cover 20 can be popped out of the sleeve 13 of the battery holder 10.

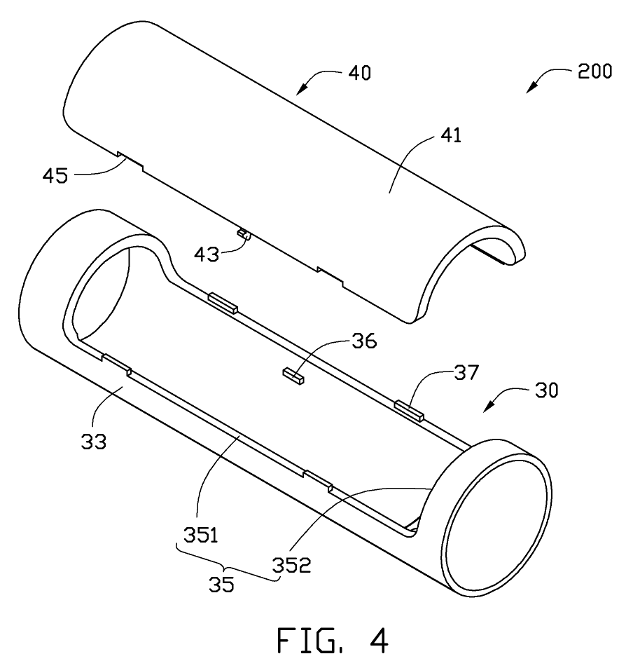

Referring to FIG. 4, a second embodiment of a fixing mechanism 200 includes a battery holder 30, and a resilient battery cover 40. The battery holder 30 includes a sleeve 33 and an elongated opening 35 defined in the sleeve 33. The sleeve 33 includes a pair of elongated edges 351 substantially parallel to the center axis X and a pair of curved edges 352 connecting the elongated edges 351. The sleeve 33 further includes a plurality of latching portions 36 and a plurality of limiting portions 37. The sleeve 33 is similar as principle to the sleeve 13 of the first embodiment, except that the latching portions 36 are protruding rims defined on an inner surface of the sleeve 33. The limiting portions 37 are protrusions extending out from the pair of elongated edges 351.

The resilient battery cover 40 includes a curved body 41, a pair of latching hooks 43 extending out from an inner surface of the curved body 41 corresponding to the latching portions 36, a plurality of latching cutouts 45 defined on an outer surface of the curved body 41 corresponding to the limiting portions 37. The latching hooks 43 are engaged with the latching portions 36, and the limiting portions 37 are received and blocked by the latching cutouts 45.

It is should be noted that the configurations of the receiving depressions 2335 are not limited to the configurations described above. Each receiving depression 2335 can be any other suitable structure. For example, each receiving depression 2335 can include three, four, or more slanted inner side surfaces 2337.

It is noted that the scope of the fixing mechanisms 100, 200 is not limited to the embodiments described above. The numbers and shapes of the latching portions 16, 36, the latching hooks 23, 43, and the limiting portions 17, 37 are specifically described and illustrated for the purpose of exemplifying various aspects of the present fixing mechanisms 100, 200.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A fixing mechanism, comprising:
a battery holder comprising a hollow sleeve, the sleeve defining a chamber to receive a battery and an opening extending along a direction substantially parallel to a center axis of the battery holder; and
a resilient battery cover sealing the opening of the battery holder, wherein the sleeve further comprises a latching portion defined in an inner surface thereof adjacent to the opening; and the resilient battery cover further comprises at least one latching hook locked with the latching portion.

2. The fixing mechanism of claim 1, wherein the battery holder further comprises a first end cover and a second end cover fixed to two ends of the sleeve by adhesive or welding.

3. The fixing mechanism of claim 2, wherein the sleeve comprises a pair of elongated edges substantially parallel to the center axis of the battery holder, and a pair of curved edges substantially parallel to the first and second end covers; the elongated edges and the curved edges cooperatively define the opening.

4. The fixing mechanism of claim 3, further comprising an elongated cutout defined on each elongated edge of the sleeve and communicating with the chamber, and a plurality of latching rims extending out from the opposite edges of the resilient battery cover corresponding to the elongated cutouts, wherein the latching rims are received in the elongated cutout and blocked by the elongated cutout.

5. The fixing mechanism of claim 1, wherein the at least one latching hook is substantially L-shaped.

6. The fixing mechanism of claim 1, wherein the latching portion is an elongated latching depression defined at an inner surface of the sleeve.

7. The fixing mechanism of claim 1, wherein the latching portion is a protruding rim defined on an inner surface of the sleeve.

8. The fixing mechanism of claim 1, wherein the resilient battery cover comprises a curved body complementing the sleeve to form an integral appearance; the at least one latching hook extends out from an inner surface of the curved body corresponding to the latching portion.

9. The fixing mechanism of claim 8, wherein the curved body is made of elastic resins or an elastic metallic sheet.

10. The fixing mechanism of claim 3, further comprising a plurality of protrusions extending out from the pair of elongated edges of the sleeve, and a plurality of latching cutouts defined on an outer surface of the resilient battery cover corresponding to the protrusions, wherein the protrusions are received in the latching cutout and blocked by the latching cutout.
